(19) United States
(12) Patent Application Publication
(10) Pub. No.: US 2006/0186010 A1
(43) Pub. Date: Aug. 24, 2006

(54) Medical device packaging and antistatic system

(76) Inventors: Boris Warnack, Rangendingen (DE); Eddie Forde, Co Galway (IE); Jim Phelan, Co Galway (IE)

Correspondence Address: WORKMAN NYDEGGER, 1000 EAGLE GATE TOWER,, 60 EAST SOUTH TEMPLE, SALT LAKE CITY, UT, 84111, US

(21) Appl. No.: 11/353,612

(22) Filed: Feb. 14, 2006

Related U.S. Application Data
(60) Provisional application No. 60/653,205, filed on Feb. 15, 2005.

(51) Int. Cl. B31B 45/00

(52) U.S. Cl. 206/438; 428/34.1

(57) ABSTRACT

An elongate medical device packaging system can include a sheath, a clasp, and/or a container. The sheath can be configured to releasably retain an elongate medical device, and can be comprised of a first material and an antistatic material in an amount and distribution within the first material so as to inhibit generating static electricity when the elongate medical device is withdrawn from the lumen. The clasp can include at least two recesses configured to hold the sheath in a coiled orientation. The clasp also has a configured to hold at least one object in an inwardly planar orientation with respect to the coiled elongate tube. The container can be a multi-compartment container, which includes one compartment to hold the coiled sheath and one compartment to hold components of the medical device, wherein each compartment can be fluid-tight.

### RELATED APPLICATIONS

This application claims the benefit of and priority to U.S. Provisional Patent Application Ser. No. 60/653,205, filed Feb. 15, 2005, and entitled “MEDICAL DEVICE PACKAGING AND ANTISTATIC SYSTEM”, the disclosure of which is incorporated herein by this reference.

### BACKGROUND OF THE INVENTION

1. The Field of the Invention

The present invention relates to devices and containers for holding and retaining medical devices. More particularly, the present invention relates to an improved medical device packaging system for use in storing and transporting one or more medical devices.

2. The Relevant Technology

Many medical devices such as endoscopes, percutaneous translumenal coronary angioplasty (“PTCA”) catheters, stent delivery catheters, balloon catheters, and the like are typically packaged within a protective sheath. For example, sheaths can protect a balloon located on the distal end of a catheter shaft as well as the shaft itself from accidental damage during storage, transit, and preparation for use. Normally, the sheath is coiled to enable the product to be packaged more efficiently in a container. Various types of retention devices have been used to retain the sheath and medical device in a coiled orientation. Additionally, various components that are operable with the medical device as well as instruction and label information are also enclosed in the container.

The proximal end of the catheter can include luer fitting, which projects clear of the sheath so that it is presented free for use by the physician. As such, the distal end of the catheter, which can include a delicate balloon, for example, can be retained safely within the coiled sheath. In addition, the sheath also retains the medical device in a sterile and clean environment. In part, this is because the medical device, sheath, and any other associated packaging (e.g., container) are typically sterilized together, wherein the sterile packaging remains sealed until use. However, the retention devices have been shown to puncture the containers and compromise sterility. Additionally, the various components and materials packaged with the medical device may compromise the integrity and sterility of the container.

Generally, the medical device is removed from the container and coiled sheath before being utilized in a medical procedure. The medical device can be rinsed with a sterile fluid such as saline solution in preparation for use. The wetted medical device is then typically placed on a sterile cloth covering a tray, or placed on a surgical drape where it remains until use. One shortcoming arises when the medical device is removed from the coiled sheath. As the medical device is being withdrawn from the sheath it has been found that a static charge builds on the device due to frictional interaction between the device and the lumen of the sheath. The formation of a static charge can cause small particles to be drawn and affix themselves to the medical device when it is placed onto the towel or drape. This is problematic because any particulates adhering to the medical device can be introduced into the patient upon percutaneous translumenal insertion.

Accordingly, various techniques, such as washing with sterilized water, have been implemented in order to remove the particulates that adhere to the medical device. Animal studies have shown pressure rinsing of coronary stents immediately before implantation can reduce inflammation and neointimal hyperplasia. See, A. Baye-Gensi et al., J AM Coll Cardiol; 38: 562-8 (2001). Additionally, a stent may attract particulates from the materials (e.g., sterile covering cloth, gloves, and the like) used during the medical procedure. More particularly, particulates and fuzzes from these materials can adhere to the stent when it is withdrawn from the sheath and placed on the table before insertion into the patient.

Therefore, it would be advantageous to have a medical device packaging system that is improved to inhibit the sterility of the medical device from being compromised. Additionally, it would be beneficial to have improved packaging materials that reduce and/or eliminate the formation of a static electric charge when a medical device is removed from its protective packaging.

### SUMMARY OF THE INVENTION

Generally, the present invention relates to packaging devices and systems for retaining medical devices. The packaging devices and systems can be configured to retain elongated medical devices such as catheters, endoscopes, and the like. Any of the various packaging devices and systems can be comprised of antistatic materials that inhibit and/or eliminate the formation of static electricity or static charge when the medical device is removed from the packaging devices or systems. The use of antistatic materials can thereby inhibit sterility from being compromised prior to use.

In one embodiment, the present invention can include a medical device sheath configured to hold and retain an elongate medical device disposed within a lumen of the sheath. The sheath can include an elongate tube having an outer surface and an inner surface defining the lumen, which is configured to releasably retain the elongate medical device. The elongate tube can be fabricated with a first material and an antistatic material. The antistatic material can be incorporated into the first material in an amount and distribution so as to inhibit the buildup of static electricity or charge. In part, the antistatic material inhibits static electricity or charge from being generated when the elongate medical device is withdrawn from the lumen.

In one embodiment, the present invention can include a clasp configured to hold and retain a medical device (e.g., catheter, endoscope, medical device sheath, etc.), during storage. The clasp can include a housing having an outer end and an inner end. The housing can include at least two recesses formed therein, and each recess can be configured for releasably retaining an elongate tube such as a sheath. Accordingly, the at least two recesses can hold the elongate tube in at least a double coil orientation so that a coil passes through each one of the recesses. As such, the recesses can be substantially parallel with respect to each other.

In one embodiment, the clasp can additionally include a holder. The holder can have an inward end and an outward end that is coupled with the inner end of the housing. The holder can be configured for releasably retaining at least one object in an inwardly generally planar orientation with respect to the coiled elongate tube. As such, the clasp can retain the coiled elongate tube and object in a substantially generally planar orientation with respect to each other.

In one embodiment, the present invention can include a multi-compartment container. The container can include two separate fluid-tight compartments for storing different portions of a medical device or medical system. Generally, the first compartment can have a shape defined by a perimeter that includes at least one fixed seal and at least one peelable seal. Additionally, the shape can be defined by a first sheet comprised of at least a first material and a second sheet comprised of at least a second material. Accordingly, the first and/or second materials can include various materials that resist being punctured by a medical device, medical device sheath, and/or clasp for holding and retaining the same in a coiled orientation.

The second compartment can include the second sheet as a boundary with the first compartment and a third sheet comprised of a third material. The second compartment can be substantially the same shape and size as the first compartment or smaller in at least one dimension. The second compartment can have a perimeter that shares at least one fixed seal with the first compartment. In one instance the entire perimeter of the third sheet has a fixed seal with the second sheet. In another instance at least a portion of the third sheet includes a peelable seal with the second sheet.

In one embodiment, the present invention can include an elongate medical device packaging system. The system can include a medical device sheath, a clasp for holding and retaining the sheath, and a multi-compartment container for holding the clasped-sheath and other components of the medical device. The multiple compartments can separate the various components of the medical device during storage, transportation, and the like to prevent damage and/or contamination that may occur when one component comes into contact with another component. Accordingly, the sheath, clasp, and multi-compartment container can be substantially the same as described herein.

One embodiment of the present invention can include a method for reducing static electricity or charge in medical device and/or packaging. Such a method can include choosing an antistatic material to be incorporated into the materials that define the medical device or packaging components. Such materials can include polyethylene, high density polyethylene, and the like, which are optionally combined or impregnated with an antistatic material. The antistatic material can be a material that is non-conductive and/or an electron scavenger that readily entraps electrons from its surroundings. The device and/packaging materials can be prepared to include the antistatic material in an amount and distribution that inhibit the generation of static electricity or charge during storage, transport, and withdrawal of the medical device from the packaging.

In one embodiment, the present invention can include a method for reducing particulate matter on a medical device. Such a method can include a process of selecting an antistatic material to be included in the medical device and/or packaging. The medical device and/or packaging can be formed to include the antistatic materials. Also, the medical device and/or packaging can be cleansed so as to remove any particular matter. Subsequently, the medical device can be disposed in a packaging, wherein either the medical or packaging has improved antistatic properties. The medical device and packaging can be sterilized and sealed so that the medical device is in a fluid-tight compartment. The medical device and/or packaging having improved antistatic characteristics can be configured such that removal of the medical device from the packaging does not result in a substantial amount of generated static electricity or charge. Thus, the medical device can then be used in a medical procedure without having a static electricity charge that draws or accumulates particulates to the surface of the device.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. Also, it should be recognized that the figures are not draw to scale or proportion with respect to any dimensions, and the shapes illustrated should not be strictly construed and only provide general features of an embodiment of the invention. The invention will be described and explained with additional specificity and detail through the use of the accompanying drawings, in which:

FIG. 1 is a perspective view that illustrates an embodiment of a medical device sheath being held by a clasp, wherein the clasp includes a holder configured for holding an information sheet;

FIG. 2 is a perspective view that illustrates an embodiment of a clasp having three recesses for releasably retaining a medical device sheath;

FIG. 3 is a perspective view that illustrate an embodiment of a clasp having a holder configured for holding an information sheet;

FIG. 4 is a perspective view that illustrates an embodiment of a clasp having a holder configured for retaining an object in the form of a flushing needle;

FIG. 5 is a perspective view that illustrates an embodiment of a clasp having a holder configured for retaining a flushing needle and a bar for holding two catheter retaining clips;

FIG. 6 is top view that illustrates an embodiment of a medical device packaging system;

FIGS. 7A-7E are schematic diagrams depicting cross-sectional side view of different embodiments of multi-compartment medical device containers;

FIGS. 8A-8C are top views that illustrate embodiments of multi-compartment medical device containers;

FIG. 9 is a cross-sectional view of an embodiment of a multi-compartment container;

FIGS. 10A-10B are cut-away views of an embodiment of a multi-compartment container;

FIG. 11 is a diagram illustrating the incorporation of a medical device and packaging system into a multi-compartment container; and

FIG. 12 is a diagram illustrating the incorporation of a medical device and packaging system into a multi-compartment container.

### DETAILED DESCRIPTION OF THE PREFERRED EMBODIMENTS

Generally, the present invention includes packaging devices and systems for retaining medical devices. The packaging devices and systems can be configured to retain elongated medical devices such as catheters, endoscopes, and the like. As such, the packaging devices and systems can allow for an elongated medical device to be efficiently packaged into a compact, coiled orientation which provides stability and protection to the medical device.

The packaging device and/or system can include a medical device sheath, medical device clasp, and multi-component container. The medical device sheath can be configured to at least substantially enclose an elongate medical device within an internal lumen to provide protection during storage, transportation, and preparation for use. The medical device clasp can be configured to stably hold the medical device with or without being retained within a sheath in a more compact orientation throughout storage, transportation, and preparation for use. The multi-compartment container can be configured to include a compartment that can store the medical device within the sheath, and a compartment that can store components associated with the medical device.

I. Medical Device Sheath

A medical device sheath can be a protective appliance that is configured to contain a medical device. While medical devices are generally described herein as elongated devices, such as catheters, endoscopes, and the like, the protective sheaths of the present invention can configured for other types of medical devices or instruments within the scope of the present invention.

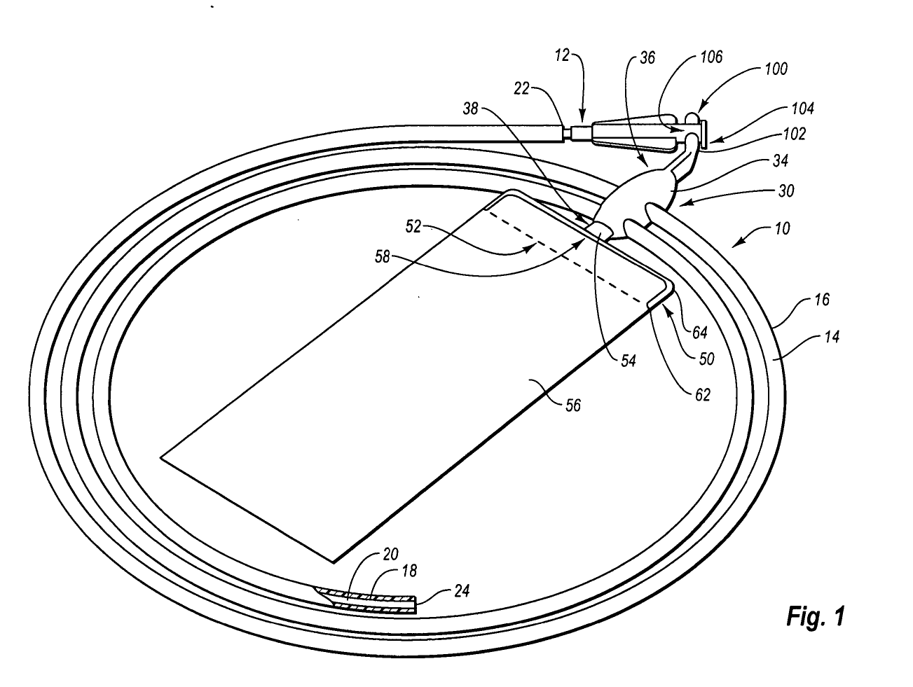

FIG. 1 provides a perspective view of an embodiment of a medical device sheath 10 in accordance with the present invention. As shown, the exemplary embodiment of the medical device is a catheter 12. The medical device sheath 10 can be comprised of an elongate tube 14 having an outer surface 16 and an inner surface 18 defining a lumen 20. The lumen 20 is configured to releasably retain an elongate medical device 12. The sheath 10 can have a first open end 22 and a second open end 24, or at least one of the ends can be sealed or have a sealable cap (not shown). Also, the outer surface 16 and/or inner surface 18 can form a substantially cylindrical shape having near uniform dimensions along the length so as to have a substantially uniform outer diameter and inner diameter. Alternatively, the outer diameter and/or inner diameter can increase or decrease from the first end 22 to second end 24.

The elongate tube 14 can be comprised of at least a first material. Usually, the material is either flexible or resiliently flexible. In the instance the material is flexible the tube can be positioned into many various orientations and shapes. For example, the material can be a rubbery material that can be bent, wound, coiled, folded, or twisted without deforming the tube or lumen, and retain the orientation without shape memory. Examples of flexible materials include flexible PVC, polyurethane, silicone, liner low-density polyethylene (“LLDPE”), polyethylene, high density polyethylene, (“DHPE”), polyethylene-lined ethylvinyl acetate (“PE-EVA”), polypropylene, latex, thermoplastic rubber, and the like. These materials can be suitable for use as a medical device sheath when configured to have chemical resistance, crack resistance, no toxicity, Food and Drug Administration (“FDA”) compliance, non-electrically conductive, dimensional stability, and/or be sterilized by ethylene oxide, gamma radiation, autoclave, UV light, ozone, and the like.

In the instance when the material is flexibly resilient, the material can be similarly bent, wound, coiled, folded, or twisted, but usually tends to return to the original shape, thereby being a material with shape memory. Most of the forgoing materials can be configured to have shape memory by being heat-set with a particular configuration. This can include coiling the tube to have a specified coil diameter and heat-setting the shape. Additionally, nylon, polyurethane, and fluoropolymer (e.g., polytetrafluoroethylene, “PTFE”) materials can be especially suited for being heat-set into a particular shape, such as a coil.

Additionally, there may be instances where it is preferred for the sheath to be prepared from metals, alloys, stainless steel, ceramics, composites, fabrics, and other materials that can be configured in accordance with the foregoing parameters. Also, ribbons prepared from these materials can be used to prepare braid-reinforced sheaths. Moreover, various fabrics prepared from natural materials or synthetic materials (e.g., carbon fibers and aramide fibers) can be used to prepare the reinforcing braid.

In one embodiment, the elongate tube can be additionally comprised of an antistatic material in an amount and distribution so as to inhibit generating static electricity when the elongate medical device is withdrawn from the lumen. Antistatic materials are described in more detail below.

II. Medical Device Clasp

A medical device clasp can be an appliance that is configured to hold and/or releasably retain a medical device in a particular conformation. This can be especially useful for elongate medical devices such as those described in connection with the medical device sheath. Additionally, the clip can be configured for use with the sheath so as to hold the sheath in a particular shape or orientation during storage, transportation, and preparation for use.

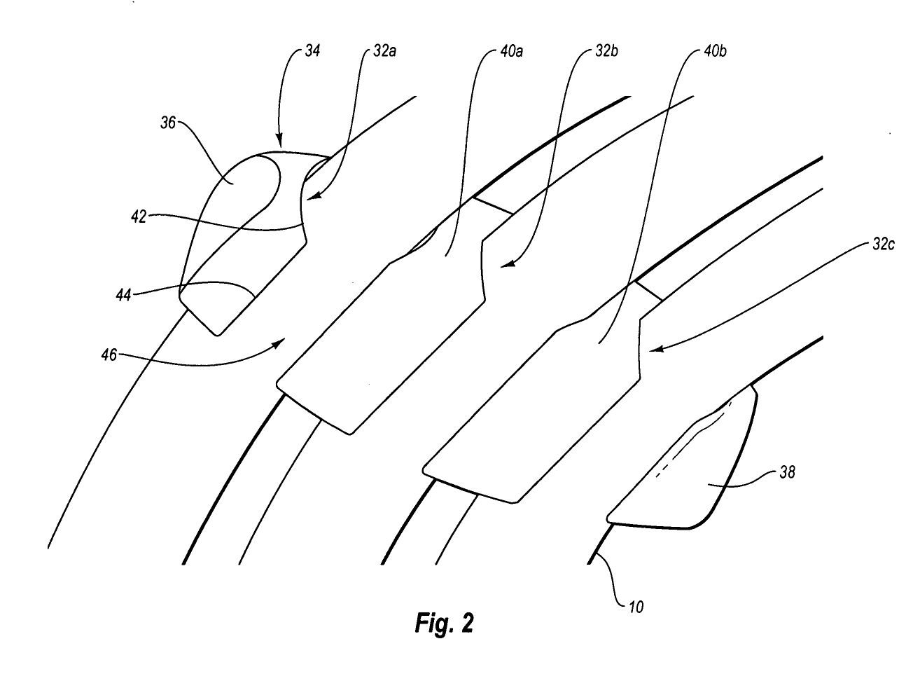

With continued reference to FIG. 1, illustrated is an embodiment of a medical device clasp 30 for releasably retaining a medical device sheath 10. The clasp 30 can be defined by a housing 34 having an outer end 36 and an inner end 38. The housing 34 can be formed to have rounded features that inhibit perforation of packaging enclosing the clasp 30. Additionally, with reference to FIG. 2, the housing 34 can include at least one recess 32, two recesses (e.g., as shown in FIG. 1), or three recesses 32a-c as depicted. Optionally, the recesses 32a-c can be formed into a single side of the housing 34, or on either side of the housing. When including more than one recess 32, one recess 32c is disposed toward the inner end 38 of the housing 34 with respect to a recess 32a disposed toward the outer end 36 of the housing.

The recesses 32a-c can be separated by a spacer 40a-b. The outer end 36, inner end 38, and spacers 40a-b can include curved surfaces 42 and lips 44 that cooperate to form the recesses 32. Each of the recesses 32 can be configured to releasably retain a sheath 10 so that the clasp 30 can hold the sheath in at least a single coil orientation; however, double coil (e.g., as shown in FIG. 1) or triple coil (e.g., as shown in FIG. 2) orientations can also be formed depending on the number of recesses 32. In the instance of having at least a double coil orientation a single coil passes through each of the recesses 32, therefore the recesses can be substantially parallel with respect to each other, although different angular orientation of adjacent recesses are possible.

The recesses 32 can have various configurations that allow for receiving and removing the sheath 10. This can include the housing 34 or portions of the housing being comprised of flexibly resilient materials that allow the opening 46 of each recess 32 to be expanded around the sheath 10 and to snap the sheath into place. Alternatively, the housing 34 can be comprised of substantially rigid or resilient materials that allow for the recesses 32 to be slid over the sheath 10 for insertion or removal. In still another configuration, the recess 32 can have flexible, substantially rigid, or rigid/resilient features that aid with selectively retaining the sheath 10. For instance, the recesses 32 can include one or more protrusions that engage with the sheath 10.

Additionally, while the recesses 32 are shown to be substantially circular, other shapes can be employed. In fact, the shape of the recesses 32 can be modified to cooperate with the shape of the medical device and/or sheath being retained therein. This can include the recesses 32 having cross-sectional shapes that range from full circles, ¾ circles, ½ circles, “U” shapes, square shapes, rectangular shapes, and other polygonal shapes.

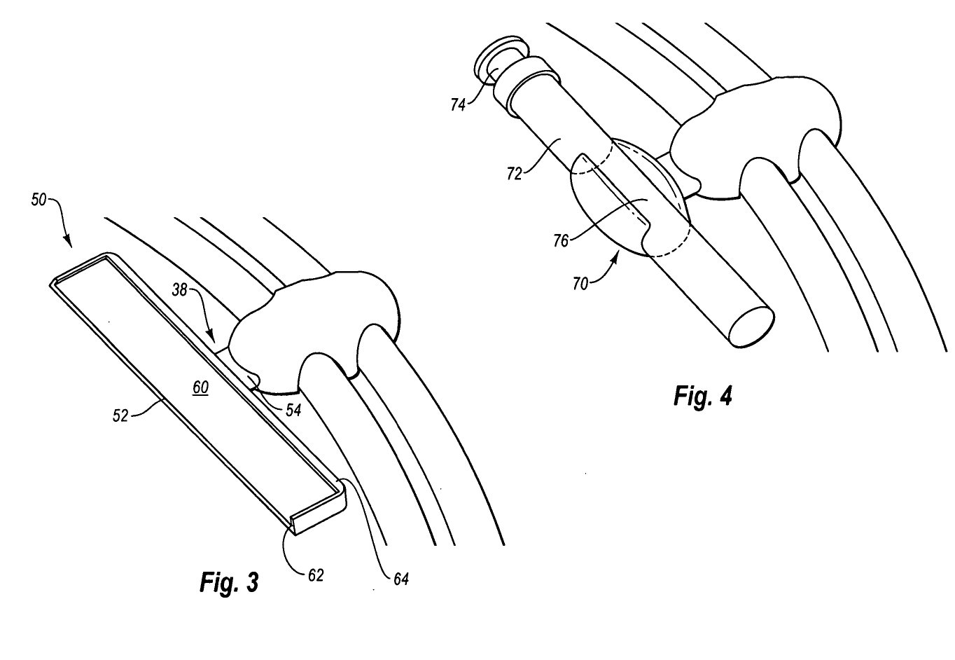

Referring to FIG. 1 and FIG. 3, the clasp 30 can include an inward holder 50 having an inward end 52 and an outward end 54 that is coupled with the inner end 38 of the housing 34. The holder 50 can be configured to releasably retain at least one object 56 in an inwardly generally planar orientation with respect to the coiled elongate tube 14 of the sheath 10. That is, the object 56 can be held and oriented so as to be substantially in a plane with respect to the coiled sheath 10. The clasp 30 is depicted to include a secondary holder 104, which is described in more detail below; however, the clasp can be configured without the secondary holder.

In one embodiment, the inward holder 50 can be configured to releasably retain at least one substantially planar substrate. The planar substrate can be any medium or material (e.g., paper or plastic) that can carry labels, markings, instructions, or other information. For example, catheters are usually supplied with a loose instruction card that is placed within a packaging; however, loose objects can be unfavorable in a medical setting. As such, the holder 50 can hold and retain the planar substrate during storage, transportation, and preparation for use.

The holder 50 can have various configurations for retaining the planar substrate. As illustrated, the holder 50 is substantially in a “T” shape having a center portion 58 with the outward end 54 coupled to the housing 34. The holder 50 can also include a substantially flat base 60 that can provide support to the planer substrate. Additionally, the holder 50 can include an elongated groove 62 extending around a perimeter edge 64. The groove 62 allows the planer substrate to fit therein in a tongue-and-groove configuration. Alternatively, the holder 50 can be configured as a pressure clip, friction clip, crocodile clip, or the like, which are well known in the art to hold planar substrates such as paper.

FIG. 4 is perspective view of another embodiment of an inward holder 70. As depicted, the inward holder 70 can be configured to releasably retain at least one component, such as a generally cylindrical component, that is usable with the elongate medical device. For example, the holder 70 can hold a needle cap 72 containing a flushing needle 74 or other similarly shaped medical devices. Accordingly, the holder 70 can include at least one recess 76, which can be configured similarly as the recesses formed in the housing. Additionally, the holder 70 can be configured as a pressure clip, friction clip, circular friction clip, “U” friction clip, crocodile clip, or the like which are well known for holding and retaining cylindrical objects. Also, the holder 70 can be configured similarly to the recesses 32 of the clasp 30 of FIG. 2.

FIG. 5 is a perspective view illustrating another embodiment of an inward holder 80. As depicted, the holder 80 can include a recess 82 for holding an object 84, and include a bar 86 coupled to the main housing 88 of the holder through a spacer 90. The bar 84 can be configured to have a shape and size that allows for a medical device 92a-b (e.g., catheter retainer clips) to be coupled therewith. As shown, the catheter clips 92a-b, which are substantially configured as alligator clips, are clipped to the bar 84. However, the bar 84 may further include a fastener (not shown) for any other medical device associated with the elongate medical device to be retained to the clasp 94. Further, although reference is made to clips being “alligator” type clips, it will be understood by one skilled in the art that various other types of clips or structures capable of selectively attaching to a medical device are possible.

In the illustrated embodiment, the bar 86 and spacer 90 are configured in a “T” conformation that provides a portion of the bar 86 on each side of the intersection with the spacer. This allows for at least one catheter clip 92a to be attached to one side of the bar 86 and at least one catheter clip 92b to be attached to the other side. Additionally, the bar 86 includes an end-cap 96a-b on each end to aid in holding and retaining the catheter clips 92a-b during storage, transportation, and preparation for use.

It will be understood by those skilled in the art that various other configurations of the bar 86 are possible. For instance, the bar can include two spaced apart generally cylindrical or curved portions, optionally similar to the bar 86, which are separated by a spacer, such as a spacer similar to spacer 90. The spacer can join or couple the two spaced apart portions along all or a portion of their lengths. In this configuration a groove or recess is formed between the two spaced apart portions. The at least one catheter clip 92a can attach to one of the spaced apart portions, while a portion of the at least one catheter clip 92a is received by the groove or recess. End caps can be located on each of the spaced apart portions and/or the spacer to aid in holding and retaining the catheter clips 92a-b during storage, transportation, and preparation for use. In this configuration, the bar aids in reducing the possibility of rotation movement of the at least one catheter clip 92a.

The groove or recess between the two spaced apart portions can be formed as the spacer can have at least one dimension smaller than the diameter of the two spaced apart portions. This can result in the cross-section of the bar having a generally or substantially lemniscate configuration or a cross-section having two generally curved or circular portions and an intermediate portion having a height or thickness smaller than the two curved or circular portions, whether or not that intermediate portion is curved or generally planar in configuration.

Various other configurations of the bar can be provided and identified by one skilled in the art in light of the teaching contained herein to perform the function of preventing or limiting rotational movement of at least one catheter clip. Further, although reference is made herein to cylindrical, curved, or circular, it will be understood that the bar or structure for supporting the at least one catheter clip can have various other cross-sectional configurations so long as the at least on catheter clip can mount thereto and optionally be received within a recess or groove associated with the bar.

Referring back to FIG. 1, a clasp 30 is described in connection with an embodiment that includes the secondary holder 100. The secondary holder 100 is coupled to the outer end 36 of the clasp 30. The secondary holder 100 is configured to improve the stability of the elongate medical device 12 when held and retained therewith. As shown, the secondary holder 100 includes an arm 102 having an off-axis bend; however, the arm can also be substantially straight. The outer end 104 of the arm 102 can include a recess 106 or is coupled to a member having a recess. The recess 106 can be configured for releasably retaining a portion of the elongate medical device 12 when extending from the first opening 20 of the elongate tube 14. The secondary holder 100 can be any type of retaining device as described herein or well known in the art.

In one embodiment, the secondary holder 100 and recess 106 cooperate to hold a substantially straight portion of the elongate medical device 12. For example, the recess 106 can be shaped and sized to releasably retain a portion of a flushing luer. Additionally, the recess 106 can vary is size and shape to accommodate other types of elongate medical devices for improved stability during storage, transportation, and preparation for use. The recess 106 can be located at various positions of the secondary holder 100. For instance, and as illustrated in FIG. 1, the recess 106 is configured so that a generally upward movement of the flushing luer relative to the recess 106, or generally perpendicular to the plane upon which the medical device sheath 10 rests, decouples the medical device 12 from the secondary holder 100. It will be understood, however, that the recess 106 can also be positioned at a distal end of the secondary holder 100. For instance, the recess 106 can be a generally C-shaped recess at the end of the secondary holder 100 and be configured so that moving the flushing luer in a direction generally outwardly from the secondary holder 100, or generally parallel to the plane upon which the medical device sheath 10 rests, will decouple the flushing luer from the recess 106. It will be understood that the orientation of the recess 106 and the particular direction a user would need to push the flushing luer or medical device 12 to decouple or disengage it from the recess 106 can be varied and would be known to those skilled in the art in light of the teaching contained herein. For instance, other configurations of the secondary holder could have a recess for receiving a portion of the medical device that would entail pushing the medical device at an angular orientation different from generally perpendicular or parallel to the plane upon which the medical device sheath 10 rests.

III. Medical Device Packaging System

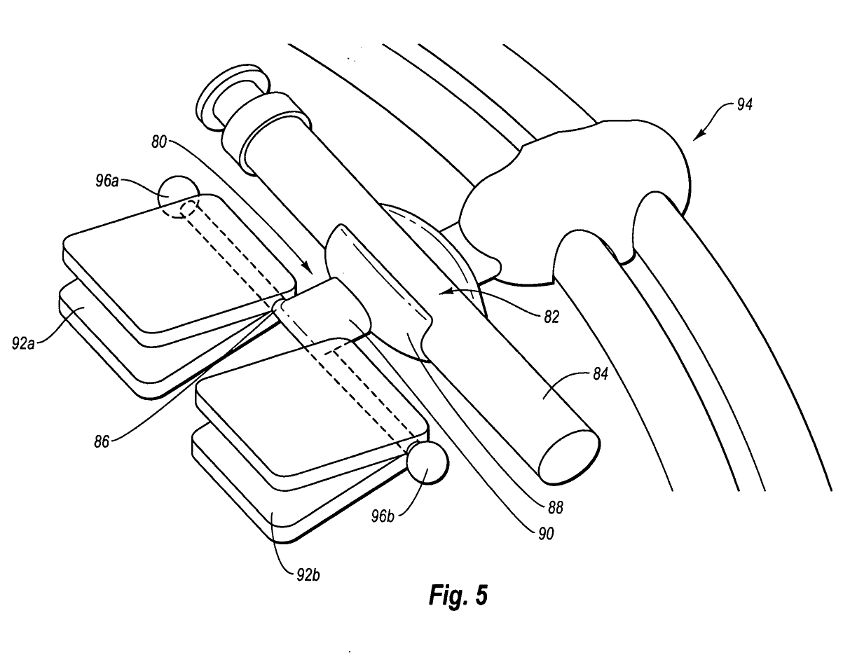

The present invention includes a medical device packaging system for holding and retaining an elongate medical device during storage, transportation, and preparation for use. Such a system can include multiple clasps having various configurations that cooperate to stably hold and retain the elongate medical device in a coiled orientation. Also, the system can include clasps to hold and retain the various components that function with the elongate medical device. The teaching of the present invention as it relates to FIGS. 1-5 can also apply to the medical device packaging of FIG. 6.

FIG. 6 is a front view of an exemplary embodiment of a medical device packaging system 120. Such a packaging system 120 can include at least one clasp as generally shown in three different embodiment referenced as 122, 124, and 126. The clasps 122, 124, and 126 can be configured to releasably retain an elongate medical device 128 or sheath 130, as described herein. The packaging system 120 can include only one clasp 126, with or without the secondary holder, as generally described in connection with FIG. 1.

In one embodiment, the packaging system 120 can include a plurality of clasps. The number of clasps can be modified in order to achieve the tight-coil orientation of the elongate medical device 128 or sheath 130 depicted in FIG. 6. This can include from two to five or more claps, wherein any embodiment of a clasp depicted and/or described herein can be used. Also, this can include two or more of the embodiment of the clasp 122 as described in connection with FIG. 2. Additionally, various modifications to the clasps described herein can be made and used with the present invention as long as the packaging system 120 can orient the medical device 128 or sheath 130 as depicted and/or described.

In another embodiment, the packaging system 120 depicted and/or described in connection with FIG. 6 can be combined with a multi-compartment container. Briefly, a multi-compartment container can be configured to include a primary compartment to retain the tight-coiled medical device that is held and retained by a plurality of clasps. The multi-compartment container can also include one or more secondary compartments configured to retain components associated with the medical device such as instruments, utensils, information pamphlets, information cards, instruction cards, and the like. An exemplary multi-compartment container is described in more detail below.

IV. Multi-Compartment Container

The present invention includes a multi-compartment container configured for retaining a medical device in one compartment and at least one other compartment configured to retain components associated with the medical device such as instruments, utensils, information pamphlets, information cards, instruction cards, and the like. At least one of the compartments can be particularly suited to retain a tight-coiled medical device that is held and retained by a plurality of clasps as described herein. The other compartment can have various configurations and orientations depending on the intended contents. The containers can be configured as boxes, contoured envelops, sleeves, pouches, and the like. As such, the containers can be configured to be rigid, semi-rigid, resiliently flexible, flexible, or the like.

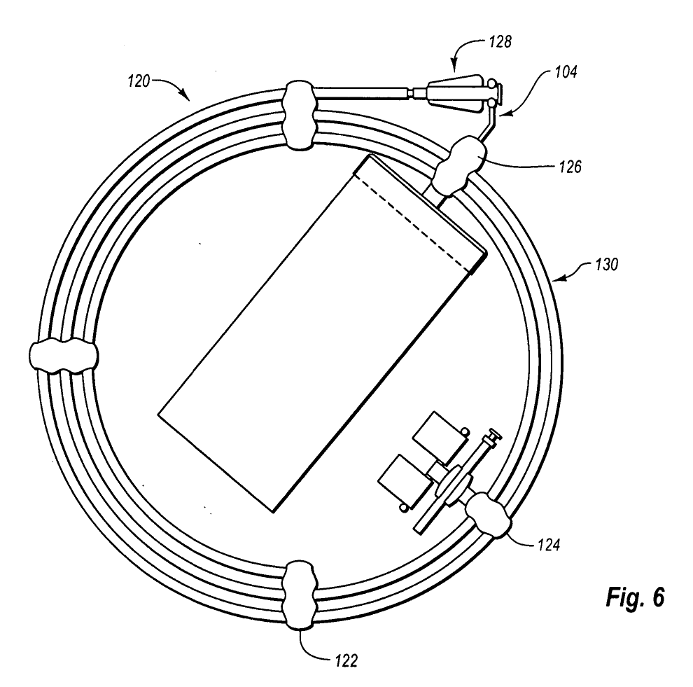

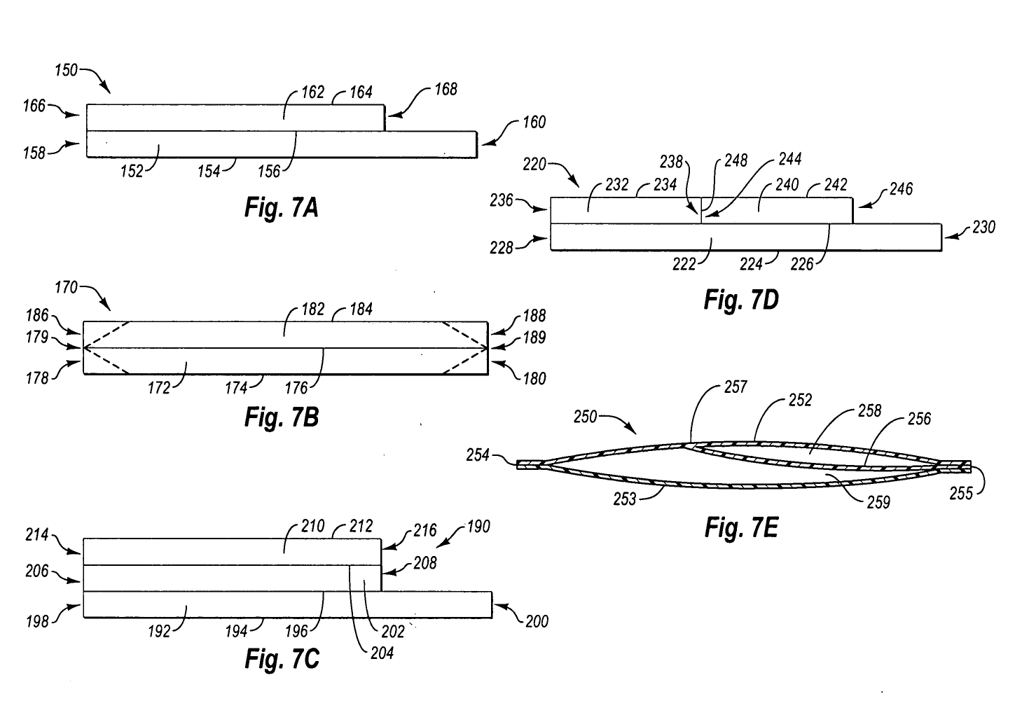

FIG. 7A is a schematic diagram illustrating a cross-sectional side view of an embodiment of a multi-compartment container 150 in accordance with the present invention. As such, the container 150 includes a first compartment 152 defined by a first wall 154, second wall 156, first end 158, and second end 160. Additionally, the container 150 includes a second compartment 162 defined by the second wall 156, third wall 164, first end 166, and second end 168. As such, the first compartment 152 and second compartment 162 are adjacent and share a common wall (e.g., second wall 156). As depicted, the first compartment 152 has a larger volume compared with the second compartment 162. Also, the first compartment 152 and second compartment 162 can share a common peripheral edge (e.g., heat seal, described in more detail below) with the illustrated first end 158 of the first compartment and the first end 166 of the second compartment coming together.

FIG. 7B is a schematic diagram illustrating a cross-sectional side view of another embodiment of a multi-compartment container 170 in accordance with the present invention. As such, the container 170 can include a first compartment 172 defined by a first wall 174, a second wall 176, a first end 178, and a second end 180. Additionally, the container 170 can include a second compartment 182 defined by the second wall 176, a third wall 184, a first end 186, and a second end 188. As such, the first compartment 172 and second compartment 182 are adjacent and share a common wall (e.g., second wall 176) extending from the first ends 178, 186 to the second ends 180, 188. Similar to the embodiment illustrated in FIG. 6A, the first ends 178, 186 can come together in a single first peripheral end 179, and the second ends 180, 188 can come together in a single second peripheral end 189.

Optionally, the multi-compartment container can be in the form of a pouch. Such a pouch can be formed from two flexible walls being joined together at a sealed intersection. The sealed intersection can be formed by heat-sealing the two walls together to form a single edge as a perimeter for each side of both compartments. For example, in FIG. 7B, the first peripheral end 179 can be formed by a seal that joins the first wall 174, second wall 176, and third wall 184 together, as shown by the dashed lines. Similarly, the second peripheral end 189 can be formed by a seal that joins the first wall 174, second wall 176, and third wall 184 together, as shown by the dashed lines. Thus, the first and second ends of the first and second compartments are seals.

FIG. 7C is a schematic diagram illustrating a cross-sectional view of another embodiment of a multi-compartment container 190 in accordance with the present invention. As such, the container 190 can include a first compartment 192 defined by a first wall 194, a second wall 196, a first end 198, and a second end 200. Additionally, the container 190 can include a second compartment 202 defined by the second wall 196, a third wall 204, a first end 206, and a second end 208. As such, the first compartment 192 and second compartment 202 are adjacent and share a common wall (e.g., second wall 196). Also, the container 190 can include a third compartment 210 defined by the third wall 204, a fourth wall 212, a first end 214, and a second end 216. Accordingly, the second compartment 202 and third compartment 210 are adjacent and share a common wall (e.g., third wall 204) extending from the first ends 206, 214 to the second ends 208, 216.

FIG. 7D is a schematic diagram illustrating a cross-sectional view of another embodiment of a multi-compartment container 220 in accordance with the present invention. As such, the container 220 can include a first compartment 222 defined by a first wall 224, a second wall 226, a first end 228, and a second end 230. Additionally, the container 220 can include a second compartment 232 defined by the second wall 226, a third wall 234, a first end 236, and a second end 238. As such, the first compartment 222 and second compartment 232 are adjacent and share a common wall (e.g., second wall 226). Also, the container 220 includes a third compartment 240 defined by the second wall 226, a fourth wall 242, a first end 244, and a second end 246. Accordingly, the first compartment 222 and third compartment 240 are adjacent and share a common wall (e.g., second wall 226). As depicted, the second compartment 232 and third compartment 240 are adjacent and share a common boundary 248 defined by the second end 238 of the second compartment and the first end 244 of the third compartment. The boundary 248 can be a wall, seal, or other similar junction.

FIG. 7E is a schematic diagram illustrating a cross-sectional view of another embodiment of a multi-compartment container 250 comprised of two outer sheets 252, 253, and an inner inserted sheet 256. More specifically, a top outer sheet 252 can be coupled with a bottom outer sheet 253 by having a first end seal 254 and a second end seal 255. Additionally, the corresponding sides (not shown) can also be coupled together with seals that extend from the first end seal 254 to the second end seal 255. An inner insert sheet 256 is disposed between a portion of the top outer sheet 252 and a portion of the bottom outer sheet 253 and sealed thereto at the second end seal 255. The inner insert sheet 256 extends from the first end or the first end seal 254 towards the second end or the second end seal 255 and terminates distal to the first end seal 254. The inner inserted sheet 256 can be coupled with the top outer sheet 252 at the median seal 257. Thus, the top outer sheet 252, bottom outer sheet 253, and inner inserted sheet 256 can form a primary compartment 259, and the top outer sheet 252 and inner inserted sheet 256 can form a secondary compartment 258. The inner insert sheet 256 can also comprise one or more sections of differing materials for different purposes, as will be described in more detail hereinafter. For instance, the inner insert sheet 256 can include at least one two sections of differing materials.

Generally, a multi-compartment container in accordance with the present invention can be prepared from any suitable material for preparing a medical device container. This can include well-known foils (e.g., Mylar®) and different grades of paper, plastics, films, and the like that are used to package medical devices. The external material should be capable of maintaining fluid-tight and/or liquid-tight compartments during storage and transportation of the medical device. Optionally, an insert material can be gas-permeable. Additionally, the materials should be capable of withstanding various sterilization processes without significant loss of its beneficial properties.

In one embodiment, the container can be comprised of a sheet of polymeric material that is formed into a clear film (e.g., transparent), gas-permeable film, soft plastic, and/or hard plastic. The clear material allows for the contents of the container to be visually identified. Gas-permeable films can allow water vapor to be removed from one of the compartments. Examples of such films include polyethylene, polyethylene terephthalate, polypropylene, polyesters, cellophane, and the like. Clear materials that can be used for packaging sterile medical devices are well known in the art. Also, the container can be comprised of a translucent or opaque polymeric material, where various polymeric materials are well known in the art to be configured as such.

Additionally, the container can be comprised of a sheet formed from polymeric materials that are metallized by incorporating various metal fibers or particles into the polymeric material. Metallized polymer sheets are also well known for use in medical device packaging.

In one embodiment, the container can be comprised of a sheet formed from fine, continuous, high-density polyethylene fibers. Such fibers are first flash spun, then laid as a web on a moving bed before being bonded together by heat and pressure. Tyvek® (i.e., heat-pressed continuous high-density polyethylene fiber) is an example of a protective sheet made of such continuous fibers, and can provide characteristics of paper, plastic, film and/or fabric.

In one embodiment, the container can be comprised of a sheet formed from a foil, such as Mylar®. Mylar® is a biaxially-oriented polyethylene terephthalate (“BOPET”) polyester film that has good tensile strength, chemical resistance, stability, transparency, and electrical insulation. However, other similar foils can also be used.

In one embodiment, the container can be comprised of a plurality of materials. Accordingly, the different walls of a container can each be made of a different material to suit the functionality of an invention. For example, in. FIG. 7A, the first wall 154 can be comprised of a foil, the second wall 156 can be comprised of Tyvek®, and the third wall 164 can be comprised of a foil or a clear plastic when it is preferable for the contents to be visible, such as when the contents are cards or pamphlets providing information regarding the medical device.

In another configuration, the first wall 154 and the third wall 164 can be made of one material, while the second wall 156 can be formed by a different material that allows gas and/or liquid to pass between the internal portion or chamber of the first compartment 152 to the second compartment 162, without direct contact between the medical device in the first compartment 152 and the chemical compound and/or component disposed in the second compartment 162. Illustratively, an oxygen and/or liquid scavenger can be placed in the second compartment 162, while a medical device can be placed in the first compartment 152. The second wall 156 can enable the scavenger to perform its desired function (e.g., eliminate oxygen and/or liquid) while preventing direct contact between the scavenger and the medical device.

Additionally, the material forming any of the walls in FIGS. 7A-7E can be comprised of a material suitable for protecting the contents thereof. This can include the Tyvek® being used for a portion or all of the walls in the compartment configured to retain an elongate medical device held in a coiled orientation with the sheath and/or clasps described herein.

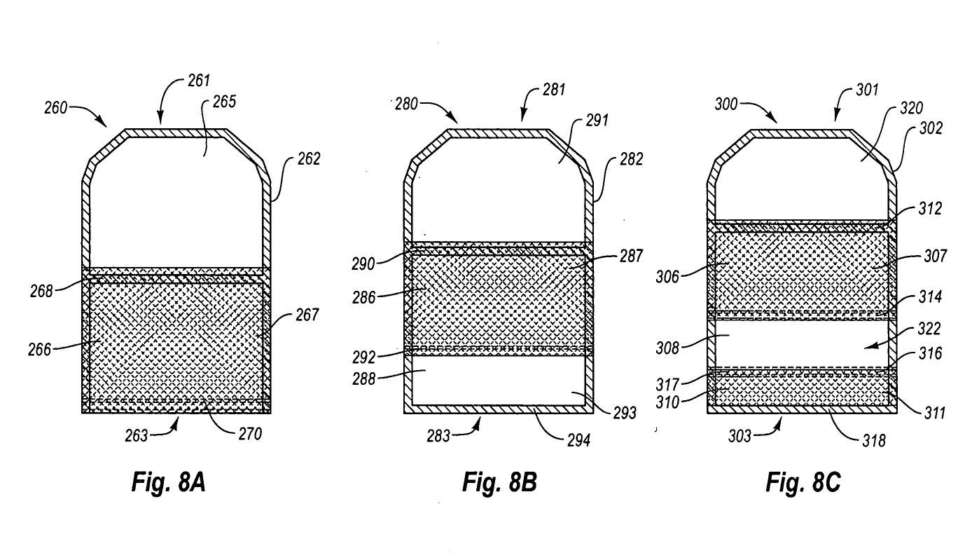

FIG. 8A is a schematic diagram that illustrates a top cut-away view of an embodiment of a multi-compartment container 260. The container 260 can include multiple layers or walls that can be any of a top outer wall (not shown in FIG. 8A for clarity), a bottom outer wall, an inner insert wall, or combination thereof. The container 260 can be in the form of a multi-compartment pouch, which can be referred to as a piggyback container, pouch, or sleeve, where one compartment piggybacks on the other compartment, which can be substantially equal in size or have different sizes, or where one compartment is contained within another compartment, as illustrated in FIG. 7E.

A perimeter seal 262 that extends about the perimeter can define the general shape of the container 260. The container 260 can include a top outer sheet (not shown) and a bottom outer sheet 266 that each extend from the first end 261 to the second end 263. The top outer sheet (not shown) can have a similar configuration to the bottom outer sheet 266. An inner insert sheet 270 is inserted between the top outer sheet and the bottom outer sheet 266. The inner insert sheet 270 is coupled to the top outer sheet at the median seal 268 and portion of the perimeter seal 262 that is between the median seal 268 and the second end 263. Accordingly, the top outer sheet from the first end 261 to the median seal 268, the inner insert sheet 270 from the median seal 268 to the second end 263, and the bottom outer sheet 266 from the first end 261 to the second end 263 define the primary compartment 265. The top outer sheet 264 from the median seal 268 to the second end 263, and the inner insert sheet 270 from the median seal 268 to the second end 263 define the secondary compartment. The top outer sheet and bottom outer sheet 266 can be comprised of a material such as Mylar® and/or Tyvek®. The inner insert sheet 270 can be a fluid-impermeable material or a fluid and/or gas permeable material such as a polyethylene Tyvek®, or vice versa.

FIG. 8B is a schematic diagram that illustrates a top cut-away view of another embodiment of a multi-compartment container 280. As with container 260, the top outer sheet is not illustrated in FIG. 8B for clarity, but it will be understood by one skilled in the art that the top outer sheet and the bottom outer sheet can have a similar configuration. The container 280 can include a perimeter seal 282 that extends about the perimeter can define the general shape of the container 280. Also, the container 280 can include a top outer sheet and a bottom outer sheet 288 that each extend from the first end 281 to the second end 283. An inner insert sheet 287 can be inserted between the top outer sheet and the bottom outer sheet 288. The inner insert sheet 287 can be coupled to the top outer sheet at the median seal 290 and portion of the perimeter seal 282 that is between the median seal 290 and the second end 283. The inner insert sheet 287 can be comprised of a first material 286 and a second material 294, which are sealed together by an insert seal 292. Accordingly, the top outer sheet from the first end 281 to the median seal 290, the inner insert sheet 287 from the median seal 290 to the second end 283, and the bottom outer sheet 288 from the first end 281 to the second end 283 can define the primary compartment 291. The top outer sheet from the median seal 290 to the second end 283, and the inner insert sheet 287 from the median seal 290 to the second end 283 define the secondary compartment 293. The top outer sheet and bottom outer sheet 288 can be comprised of a material such as Mylar® and/or Tyvek®. The first material 286 of the inner insert sheet 270 can be a fluid-impermeable material, and the second material 294 of the inner insert sheet can be a fluid and/or gas permeable material such as a polyethylene, Tyvek®, or vice versa.

FIG. 8C is a schematic diagram that illustrates a top cut-away view of another embodiment of a multi-compartment container 300. As with containers 260 and 280, the top outer sheet is not illustrated in FIG. 8C for clarity, but it will be understood by one skilled in the art that the top outer sheet and the bottom outer sheet can have a similar configuration. The container 300 can include a perimeter seal 302 that extends about the perimeter can define the general shape of the container 300. Also, container 300 can include a top outer sheet and a bottom outer sheet 318 that each extend from the first end 301 to the second end 303. An inner insert sheet 307 can be inserted between the top outer sheet and the bottom outer sheet 318. The inner insert sheet 307 can be coupled to the top outer sheet at the median seal 312 and portion of the perimeter seal 302 that is between the median seal 312 and the second end 303. The inner insert sheet 287 can be comprised of a first material 306, second material 308, and third material 310. The first material 306 and the second material 308 can be sealed together with a first insert seal 314, and the second material 308 and third material 310 can be sealed together with a second insert seal 316. Accordingly, the top outer sheet from the first end 301 to the median seal 312, the inner insert sheet 307 from the median seal 312 to the second end 303, and the bottom outer sheet 318 from the first end 301 to the second end 303 can define the primary compartment 320. The top outer sheet from the median seal 312 to the second end 303, and the inner insert sheet 307 from the median seal 312 to the second end 303 define the secondary compartment 322. The top outer sheet and bottom outer sheet 318 can be comprised of a material such as Mylar® and/or Tyvek®. The first material 306, second material 308, and third material 310 can be comprised of the same materials, alternating materials or different materials; however, it is preferable for the first material and third material to be fluid impermeable and the second material to be gas and/or liquid permeable.

Alternatively, FIG. 8C can illustrate an embodiment of a container 300 before being utilized as a package. In this configuration, the top outer sheet can extend from the first end 301 to the top opening 317. Additionally, the inner insert sheet 307 can extend from the median seal 312 to the second end 303, and the bottom outer sheet 318 can extend from the first end 301 to the second end 303. After the medical device is inserted into the primary compartment 320 and an associated component, information pamphlet, and/or liquid scavenger is inserted into the secondary compartment 322, the seal at 316 is heat sealed and the extra flap 311 is removed.

An inner insert sheet that includes multiple sections can be prepared to have various configurations. In one embodiment, the individual sections can be coupled together along an end of each section. This results in a single ply sheet having multiple sections. In another embodiment, laying multiple sheets in a sequential order can form the inner insert sheet having multiple sections with some sections having multiple layers.

The foregoing characterizations of inner insert sheet can be applied to any wall or sheet of a multi-compartment container, such as the top outer sheet, bottom outer sheet, and/or the like. Also, the use of multiple sections having different compositions and/or physical properties can be tailored to the needs of the medical device being retained therein as well as environmental conditions, such as humidity, and/or physical properties. This can include the use of stronger materials at the locations where damage can be more likely to occur such as at the clasps, device ends, and the like. Also, the material for a particular section can be based on the need or desire to visually identify the medical device being retained therein. For example, a wall can have a Tyvek® portion for strength, and a clear polyethylene portion for providing visual identification of the enclosed medical device. Additionally, a fluid permeable section can be used to improve moisture entrapment when a liquid scavenger is placed in the secondary compartment or a compartment other than where the medical device is stored. Cost can also be a factor for using walls with multiple sections having different compositions. This can allow for cheaper materials to be included at locations where there is less susceptibility for puncturing the wall. Thus, the medical device can be placed within the container so that portions that can be more damaging are disposed adjacent to stronger materials.

The container can be prepared in many different shapes and sizes. This can include various shapes and sizes for the primary compartment, and secondary compartment. As such, the container is not limited by shape and size. For example, a container configured for holding a coiled catheter can include an overall length of about 375 mm, an overall width of about 274 mm, and a primary compartment having an inner width of about 231 mm. The secondary compartment can include a length of about 126 mm, an overall width of about 274 mm, and an inner width of about 231 mm.

Additionally, the various seals that impart fluid-tightness to the container and independent compartments can be configured to withstand various forces. This can ensure the individual compartments retain their fluid-tightness during storage and transportation. For example, the width of the seal can range from about 3 mm to about 12 mm, more preferably about 5 mm to about 10 mm, and most preferably about 7 mm. The double seals can be comprised of individual seals having the foregoing dimensions, which can result in a total width that is substantially double the width of a single seal, or wider depending on the space between the first seal and second seal.

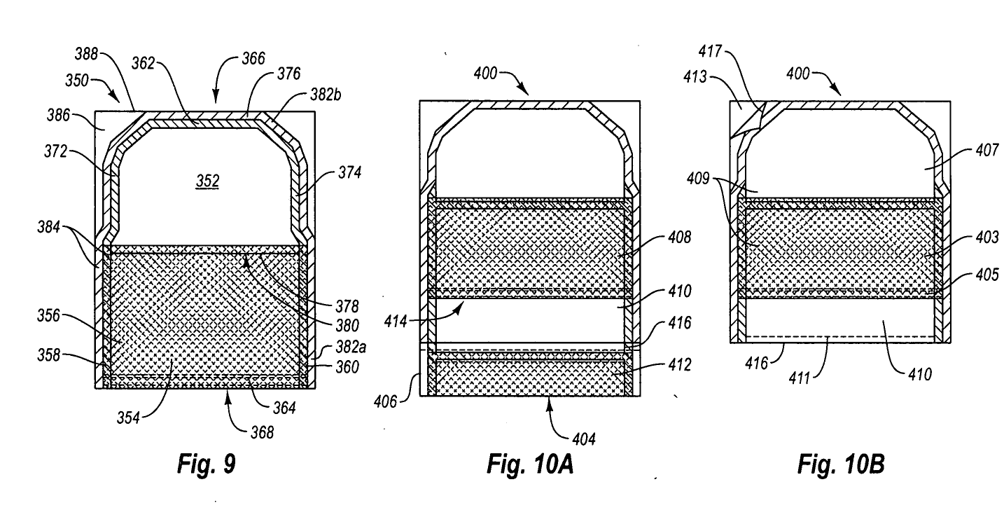

FIG. 9 is schematic diagram illustrating a cut-away view of an embodiment of a multi-compartment container 350 in accordance with the present invention. As shown, the multi-compartment container 350 can include a primary compartment 352 having a secondary compartment 354 coupled thereto. A bottom outer sheet 388 can be disposed underneath and coupled with a top outer sheet 386. A head outer seal 376 that extends to a head outer edge seal 382b and a tail outer edge seal 382a can couple the bottom outer sheet 388 to the top outer sheet 386. Optionally, the top outer sheet 386 and bottom outer sheet 388 can be coupled together with a peelable adhesive. An inner insert sheet 356 can be disposed between the top outer sheet 386 and bottom outer sheet 388. The inner insert sheet 356 can be sealed to the top outer sheet 386 at a first insert seal 358 opposite of a second insert seal 360, and at a median seal 378 at the top insert end 354 and a tail end seal 364 at the tail end 368. A double seal 384 can be comprised of outer seals 376, 382a, 382b and the insert seals 358, 360. Optionally, a first inner seal 372 and a second inner seal 374 can also couple the top outer sheet 386 to the bottom outer sheet 388.

The primary compartment 352 can be defined by the top outer sheet 386 from the head end 366 to the median seal 378, the inner insert sheet 356 from the median seal 378 to the tail end 368, and the bottom outer sheet 388 from the head end 366 to the tail end 368. The secondary compartment 354 can be defined by the top outer sheet 386 from the median seal 378 to the tail end 368, and by the inner insert sheet 356 from the median seal 378 to the tail end 368.

In one embodiment, the container 350 can be prepared by sealing the inner insert sheet 356 to the top outer sheet 386 by forming the first insert seal 358 opposite the second insert seal 360, and at the median seal 378. The tail end 368 can be left open. The bottom outer sheet 388 can be placed adjacent to the top outer sheet 386 and the inner insert sheet 356 and sealed with a peelable adhesive that extends around the periphery of the primary compartment 352, which can include the outer seals 376, 382a, 382b and/or the inner seals 362, 372, 374, as well as any of the other seals. Optionally, the outer seals 376, 382a, 382b can be heat seals that form a more secure coupling. After the medical device is placed in the primary compartment 352 and the components, information pamphlets, and/or fluid scavengers are placed in the secondary compartment 352, the tail end seal 364 can be formed by a heat seal, peelable seal, combination thereof, or the like.

In one embodiment, the outer seals can be formed by an external material that covers substantially the entire container so as to form an external surface. As such, the double seals can be formed of the external material as well as the bottom outer sheet, top outer sheet, and/or inner insert sheet. The external material can be any suitable material for forming and external covering on medical devices, electronics, and the like; however, substantially any material can be used as the external surface in instances where the primary compartment and secondary compartment are sealed from the external material. For example, the external material can be any material described herein, where preferable materials include foils, Mylar®D, Tyvek®, cellophanes, hard plastics, soft plastics, and like covering materials.

FIGS. 10A-10B illustrate a cut-away view of an embodiment of a method of forming a multi-compartment container 400. FIG. 10A illustrates the container 400 being configured similar as described in connection with the container 350 of FIG. 9; however, the inner insert sheet 404 includes three separate sections 408, 410, 412 before being sealed. As such, the first section 408 is coupled to the second section 410 through a heat seal 414, and the second section 410 is coupled to the third section 412 through a heat seal 416. However, other types of seals commonly used for coupling multiple sheets together can be used.

FIG. 10B illustrates the container 400 after the primary compartment 407 and the secondary compartment 403 are sealed. As such, after the medical device is placed in the primary compartment 407 so as to be at sections 409, and after the components, information pamphlets, and/or liquid scavengers are placed within the secondary compartment 403, the tail end seal 416 is formed. Accordingly, the flap section 406 (FIG. 10A) is cut away from the container 400 during the formation of the tail end seal 416 to form a sealed tail end 411.

Additionally, FIG. 10B illustrates a method for selectively opening the primary compartment 407. This is performed by manually pealing the top sheet 417 from the bottom sheet 413. As such, the top sheet 417 can be adhered to the bottom sheet 413 by a peelable adhesive.

Additionally, while selected embodiments have been illustrated and described in connection with the present invention, the various aspects of such embodiments can be combined and/or modified under the scope of the present invention. Thus, variations of the multi-compartment container can be made without deviating from the scope of the present invention.

V. Multi-Compartment Container And Packaging System

The present invention can include a multi-compartment container and packaging system configured for retaining an elongate medical device and associated components in different compartments. Accordingly, the multi-compartment containers, packaging systems, and packaging components can be combined in order to provide an effective system for storing, transporting, and preparing a medical device.

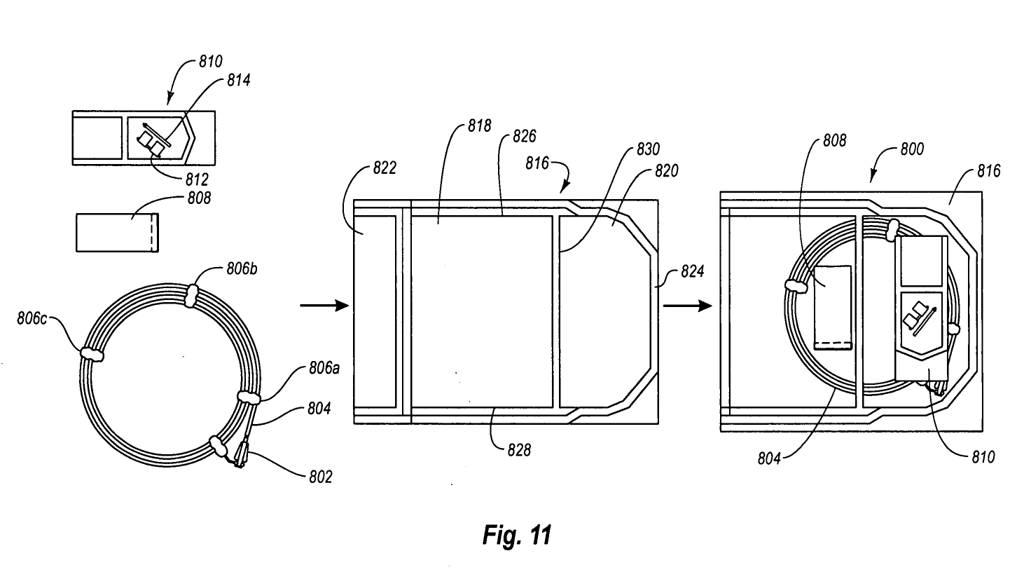

FIG. 11 is a schematic diagram of an embodiment of a multi-compartment container and packaging system 800. As depicted, the system 800 can include an elongate medical device 802 (e.g., catheter) encased within a sheath 804, which is held in a coiled orientation with clasps 806a-c. It can also include a substrate 808 having indicia regarding the medical device such as label information, instructions for use, and the like. It can also include a pouch 809, which can include medical device components, such as catheter clips 812, flushing needles 814, and the like depending on the device. It can also include a multi-compartment container 816 comprised of at least a first compartment 818, a second compartment 820, a sealable flap 822 that seals to a wall of the container when folded back thereon. As depicted, the coiled medical device 802 can be inserted into and retained in the first compartment 818, and the pouch 809 having the medical device components is inserted into and retained in the second compartment 820. The substrate is shown to be within the first compartment 818; however, it could be in a third compartment (not shown) or adhered to the front of the first compartment 818.

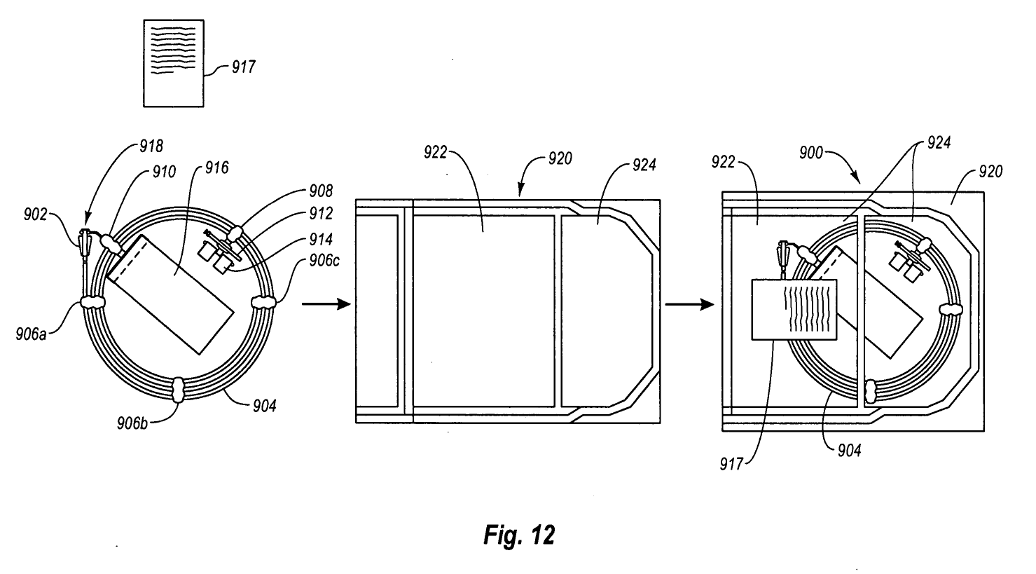

FIG. 12 is a schematic diagram of an embodiment of a packaging system 900. As depicted, the system 900 can include an elongate medical device 902 (e.g., catheter) encased within a sheath 904, which is held in a coiled orientation with clasps 906a-c, 908, 910. Clasp 908 can be configured to hold a flushing needle 910 and catheter clips 912, and clasp 914 can be configured to hold a substrate 916 and a protruding end 918 of the medical device 902. The medical device 902 can be packaged in a container 920 with an additional component, information pamphlet, and/or liquid scavengers generally designated by the pamphlet 917. The container 920 can be comprised of at least a first compartment 924 configured to hold and retain the coiled medical device 902 in the sheath 904, and an optional second compartment 922 can be used for holding the additional components, information pamphlets 917, and/or liquid scavengers. Optionally, the container can include only a single compartment or any number of compartments as needed.

As described in more detail within the Examples section below, it has been discovered that the amount of particulate matter capable of attaching to a medical device can be reduced through the selection of antistatic materials that reduce the formation of a static electric charge on the medical device. Additionally, a multi-compartment container in accordance with the present invention can be comprised of an antistatic material. Accordingly, the multi-compartment container containing the medical device within the sheath can be sterilized as a single component, wherein the container and protects the medical device and sheath from contamination during storage and shipping without compromising sterility.

VI. Antistatic Components

The present invention provides improved antistatic materials to be included in the medical packaging, containers, and systems described herein. Additionally, the antistatic materials can also be included in a medical device (e.g., catheter, endoscope, and the like) to inhibit the generation of static electricity. The use of antistatic materials in the medical devices and/or packaging can inhibit the generation of static electricity when the medical device is withdrawn from container and sheath. While the antistatic materials are generally described in connection to the sheath and containers of a packaging system, it should be recognized they can also be utilized in any medical device for enhanced antistatic characteristics.

In one embodiment, a sheath in accordance with the present invention can be comprised of a first material, such as a plastic, metal, ceramic, combination thereof or material described herein in order to provide a flexible and strong protective package. Accordingly, the sheath can have the properties as described herein. Additionally, the sheath can also include an antistatic material distributed throughout the first material so as to prove an antistatic medical device packaging. The sheath can be configured to include the first material and the second material in a manner that does not alter the properties of the medical device disposed within the sheath by using materials that are substantially inert with respect to the material of the medical device. Also, the materials that comprise the sheath can result in a lumen that does not significantly interact with lubricants commonly applied to medical devices, which can be a consequence of using the chemically stable materials described herein.

In one embodiment, the first material can be any of the materials described herein in connection with the sheath so as to provide the desired features of the sheath. For example, the first component can be preferably polyethylene or high-density polyethylene; however, other materials can be used.

The antistatic material can by any type of material that inhibits the formation of static electricity by being electrically non-conductive, or being an electron scavenger. For example, the antistatic material can be selected from the group consisting of polytetrafluoroethylene (“PTFE”), fluorinated ethylene-propylene polymer (“FEP”), carbon-filled polymer, glycerolmonostearate, ethoxylated alkylamine, nonionic ethoxylated alkylamine, lauric diethanol amine, alkyl sulfonates, alkyl dimethyl benzyl ammonium chloride/bromide, anionic aliphatic sulfonate/phosphates, quaternary ammonium compounds, glass-impregnated polystyrene, glass-impregnated acrylonitrile butadiene styrene polymers, antistatic polycarbonate, cationic scavengers, and combinations thereof. Additionally, in some instances it can be preferred for the antistatic material to be selected from the group consisting of polytetrafluoroethylene, fluorinated ethylene-propylene polymer, carbon-filled polymer, glycerolmonostearate, ethoxylated alkylamine, and combinations thereof.

The antistatic material can be combined into the sheath, clasps, container or other packaging material for the medical device so as to inhibit the generation of static electricity. This can include forming the sheath, clasps, container or other packaging material to include the antistatic material at from about 0.5% to about 49% by weight, more preferably from about 5% to about 39% by weight, and most preferably from about 10% to about 29% by weight.

In another embodiment, a hygroscopic material can be combined with the first material. Optionally, the hygroscopic material can be present in an amount and distribution so as to absorb water present within the sheath and/or container. The presence of a hygroscopic material can serve to bind excess water, and can also be a supplemental antistatic agent. In part, this is because water bound within the hygroscopic material may be inhibited from contributed to the generation of static electricity and/or can keep the conductivity relatively constant. Also, the use of a hygroscopic material can allow for the contents of the sheath and/or container to be maintained reasonably independent of the humidity at which the package is stored. Moreover, the hygroscopic material can inhibit degradation over time and/or in response to environmental conditions.

The hygroscopic material can by any material that binds and retains water. In some instances it can be preferred for the hygroscopic material to be a hydroscopic scavenger. For example, the hygroscopic scavenger can be selected from the group consisting of phosphorous pentoxide, ethanol, methanol, glycerin, sodium hydroxide, H₂SO₄, ZnSO₄, CaCl₂, SiO₂, NaNO₃, CaSO₄, and combinations thereof.

The hygroscopic material can be combined into the sheath, clasps, container or other packaging material for the medical device for any of the purposes described herein. This can include forming the sheath, clasps, container or other packaging material to include the hygroscopic material at from about 0.05% to about 10% by weight, more preferably from about 0.5% to about 5% by weight, and most preferably from about 1% to about 2.5% by weight.

Additionally, an embodiment of the present invention can include a method of reducing static electricity in a medical device. Such a method can include selecting an appropriate material as a major component of a sheath and/or container. This can include selecting the major component material from polyethylene, high density polyethylene, or the like as described herein. In any event, the major component material can be a material that does not contribute to the generation of static electricity. The method can then include selecting an antistatic material to be a minor component of the sheath and/or container. This can also include selecting an effective amount of antistatic material so as to inhibit the generation of static electricity in the medical device during storage, transportation, and preparation for use. The sheath and/or container can be formed from at least the major component material and minor component antistatic material. Also, the medical device, which can optionally also include an antistatic material, can then be packaged in the sheath and/or container and sterilized. The sterilization process can include any well known process such as ethylene oxide (“ETO”) flushing, gamma radiation, UV radiation, ozone flushing, heat-baking, autoclaving, and the like.

In another embodiment, the present invention can include a method of reducing particulate matter on a medical device. Such a method can include forming a medical device, sheath, and/or container to include an effective amount of an antistatic material distributed within a major component material that does not contribute to static generation. The method also includes packaging the medical device in the sheath, and inserting the sheath in the container. The medical device and sheath can be sterilized at any time, which can include before or after being inserted within the container. Thus, withdrawal of the medical device from the sheath and/or container can have reduced static electricity generation.

Additionally, it should be recognized that although the present invention has been generally described in connection with an elongate medical device, such as a endoscope or catheter, it is contemplated that the sheath and/or container could be configured for and utilized with other types of medical devices where there is a desire to reduce the formation of static electricity. For example, packing trays for medical devices may be prepared from the majority component materials and/or antistatic materials as described herein. This can serve to reduce the formation of static electricity formation when any type of medical device is removed from its packaging.

### EXAMPLES

### Example 1

A series of experiments were conducted to determine the effect of an antistatic material for inhibiting the generation of static electricity. More particularly, the experiments were performed to demonstrate medical devices disposed within antistatic sheaths can attract less foreign material compared to ordinary sheaths. Briefly, the experiments included the following: (a) collect dust particles; (b) pack one catheter in a standard HDPE sheath and another in an antistatic sheath; (c) remove each catheter from its corresponding sheath; (d) place a portion of each catheter into the dust particles; and (e) evaluate the amount of dust adhering to each catheter. Accordingly, the foregoing experimental protocol showed much less dust to be attracted to and collect on the antistatic catheter in comparison to the standard catheter. Thus, antistatic materials can be useful to help retain catheter sterility during the preparation of using the same.

In accordance with the present invention there is provided a process for reducing particulate matter on a medical device due to the formation of a static charge on the medical device. In accordance with the process of the present invention, a material or materials, having good anti-static properties are chosen for the formation of packaging for a medical device. After selecting a material, packaging for the medical device is formed from the material(s) and a medical device is disposed within the packaging. The device remains within the packaging until use.

Although the present invention has been described in accordance with the methods, processes or packaging embodiments described above for reducing the formation of a static electricity charge on the medical device when it is removed from the packaging, it shall be understood that the processes and methods disclosed herein may be utilized to manufacture medical devices having improved anti-static properties. Wherein, the device would be manufactured of the material(s) described above which exhibit good anti-static properties, therefore the formation of a static charge on the device would be reduced or eliminated.

It is further contemplated that although the packaging and methods in accordance with the present invention has been described as being utilized for medical devices that are to be used internally within a patient's body, it is contemplated that the packaging and methods according to the present invention may be used for medical devices that may be utilized for other procedures, for example, devices that are used topically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Although the present invention has been described in connection with the preferred form of the device and methods of practicing it and modifications thereto, those of ordinary skill in the art will understand that many other modifications can be made thereto within the scope of the claims that follow. Accordingly, it is not intended that the scope of the invention in any way be limited by the above description, but instead be determined entirely by reference to the claims that follow.

What is claimed is:

1. A medical device storage apparatus, the apparatus comprising:
a housing having an outer end and an inner end;
in the housing at least two recesses each configured for releasably retaining an elongate packaging tube in at least a double coil orientation so that a coil passes through each one of the recesses, the recesses being substantially parallel with respect to each other; and
a holder having an inward end and an outward end that is coupled with the inner end housing and configured for releasably retaining at least one object in an inwardly planar orientation with respect to the coiled elongate packaging tube, wherein the storage apparatus retains the coiled elongate packaging tube and object in a substantially planar orientation.

2. A storage apparatus as in claim 1, wherein the at least two recesses are formed into a single side of the housing.

3. A storage apparatus as in claim 1, wherein one of the at least two recesses is disposed toward the inner end of the housing with respect to the other elongate recess.

4. A storage apparatus as in claim 1, wherein the holder is configured to releasably retaining at least one substantially planar substrate.

5. A storage apparatus as in claim 4, wherein the holder is at least one of a pressure clip, friction clip, crocodile clip, or tongue-and-groove clip.

6. A storage apparatus as in claim 1, wherein the holder is configured to releasably retaining at least one cylindrical component that is usable with the elongate medical device.

7. A storage apparatus as in claim 1, wherein the cylindrical component is a needle cap containing a flushing needle.

8. A storage apparatus as in claim 6, wherein the holder is at least one of a pressure clip, friction clip, circular friction clip, “U” friction clip, or crocodile clip.

9. A storage apparatus as in claim 6, further comprising a bar coupled to inward end of the holder, the bar being configured to releasably retain at least one catheter retaining clip when coupled therewith.

10. A storage apparatus as in claim 9, wherein the bar is includes a middle portion and two end-caps, the middle portion forming a “T” intersection with the holder, and the two end-caps being spaced from the middle section by a length that accommodates at least one catheter retaining clip between the “T” intersection and each end-cap.

11. A storage apparatus as in claim 1, wherein an external surface of the storage apparatus is shaped with rounded features that inhibit perforation of a polymeric package enclosing the medical device.

12. A storage apparatus as in claim 1, further comprising a secondary holder coupled with the outer end of the housing, the secondary holder being comprised of an arm having an off-axis bend and at the end of the arm a recess configured for releasably retaining a cylindrical portion of the elongate medical device extending from the elongate packaging tube.

13. A storage apparatus as in claim 12, wherein the cylindrical portion is a portion of a flushing luer.

14. A storage apparatus as in claim 11, wherein the housing includes an effective amount of an antistatic material.

15. A medical device sheath comprising;
an elongate tube having an outer surface and an inner surface defining a lumen to receive an elongate medical device, the elongate tube being comprised of a first material and an antistatic material in an amount and distribution so as to inhibit generating static when the elongate medical device is withdrawn from the lumen.

16. A sheath as in claim 15, wherein the antistatic material is selected from the group consisting of polytetrafluoroethylene, fluorinated ethylene-propylene polymer, carbon-filled polymer, glycerolmonostearate, ethoxylated alkylamine, nonionic ethoxylated alkylamine, lauric diethanol amine, alkyl sulfonates, alkyl dimethyl benzyl ammonium chloride/bromide, anionic aliphatic sulfonate/phosphates, quaternary ammonium compounds, glass-impregnated polystyrene, glass-impregnated acrylonitrile butadiene styrene polymers, antistatic polycarbonate, cationic scavengers, and combinations thereof.

17. A sheath as in claim 16, wherein the antistatic material is selected from the group consisting of polytetrafluoroethylene, fluorinated ethylene-propylene polymer, carbon-filled polymer, glycerolmonostearate, ethoxylated alkylamine, and combinations thereof.

18. A sheath as in claim 15, wherein the first material is polyethylene or high-density polyethylene.

19. A sheath as in claim 15, further comprising a hydroscopic scavenger.

20. A sheath as in claim 19, wherein the hygroscopic scavenger is selected from the group consisting of phosphorous pentoxide, ethanol, methanol, glycerin, sodium hydroxide, H₂SO₄, ZnSO₄, CaCl₂, SiO₂, NaNO₃, CaSO₄, and combinations thereof.

21. A multi-compartment container for packaging a medical device, the container comprising:
a top outer sheet having a first end and a second end;
a bottom outer sheet sealed to the top outer sheet around a peripheral edge to define a first compartment;
an inner insert sheet disposed between the top outer sheet and the bottom outer sheet, the inner insert sheet extending from the first end towards the second end and terminating distal from the second end to define a second compartment, the inner insert comprising at least two sections of differing materials.

22. A container as in claim 21, wherein a first section of the at least two sections is comprised of a heat-pressed continuous high-density polyethylene fiber and a second section of the at least two sections is comprised of a liquid permeable material.

23. A container as in claim 22, wherein the inner insert is comprised of the first section having a different composition from the second section.

24. A container as in claim 24, wherein container includes a double seal around at least a portion of the peripheral edge seal.

25. A container as in claim 24, wherein a portion of the peripheral edge seal that couples the bottom outer sheet with the top outer sheet is a peelable adhesive.

26. A container as in claim 25, wherein a heat seal is positioned inward from the peelable adhesive.

27. A container as in claim 24, wherein the peelable adhesive covers an area sufficient for opening the primary compartment.

28. A container as in claim 27, wherein a primary compartment is defined by the top outer sheet, the bottom outer sheet, and the inner insert sheet.

29. A container as in claim 28, wherein a second compartment is defined by the top outer sheet and the inner insert sheet.

30. A container as in claim 29, wherein at least one of the top outer sheet, the bottom outer sheet, and the inner insert sheet each are comprised of a material selected from a group consisting of a foil, polyethylene, high-density polyethylene, polyethylene terephthalate, a heat-pressed continuous high-density polyethylene fiber, cellophane, fluid permeable material, and combinations thereof.
